(19) United States
(12) Patent Application Publication
(10) Pub. No.: US 2026/0232407 A1
(43) Pub. Date: Aug. 13, 2026

(54) ORTHODONTIC DEVICE

(71) Applicant: Mohammad IZADI, Timonium, MD (US)

(72) Inventor: Mohammad IZADI, Timonium, MD (US)

(21) Appl. No.: 19/152,180

(22) PCT Filed: Jan. 31, 2024
(86) PCT No.: PCT/US2024/013760

§ 371 Date: Jul. 30, 2025

Related U.S. Application Data
(60) Provisional application No. 63/482,365, filed on Jan. 31, 2023.

(51) Int. Cl. A61C 7/22; A61C 7/36

(52) U.S. Cl. CPC A61C 7/22; A61C 7/36

(57) ABSTRACT

A device for orthodontic treatment having a variable tension pull rod having a two-piece construction including an elongated spring with a threaded portion at one end and a threaded rod with a correspondingly threaded portion to fit into the spring threaded portion. A first locking module is connected to an end of the elongated spring and a second locking module is connected to an end of the threaded rod. The second locking module is located opposite to the first locking module.

### BACKGROUND

Orthodontic devices are used to correct misaligned teeth and jaws. Such devices include traditional braces, clear aligners, and functional appliances. Forsus™ is a functional appliance that is commonly used in the treatment of Class II malocclusion, which is a condition where the upper teeth protrude over the lower teeth. The Forsus™ appliance is a fixed device that attaches to the upper and lower braces and applies continuous force to align the bite.

Occlusion refers to the way the upper and lower teeth come together when the jaw is closed. Orthodontic treatment may be necessary to correct an improper occlusion, such as an overbite or underbite. This can be achieved through the use of braces, aligners, and functional appliances like Forsus™ or others. Orthodontic treatment can help improve the appearance of the teeth and jaws, as well as the function of the bite, resulting in improved oral health and self-esteem.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1(a) and 1(b) are views of a lower jaw and/or teeth having Class III skeletal and dental issues that need to be corrected and an orthodontic device correcting an upper jaw and/or teeth, according to at least one embodiment of the present invention.

FIGS. 2(a) and 2(b) are views of an orthodontic device, according to at least one embodiment of the present invention.

FIG. 3 is two views of a first locking module usable in conjunction with an orthodontic device, according to at least one embodiment of the present invention.

FIG. 4 is a photograph of another approach to a first locking module of an orthodontic device, according to at least one embodiment of the present invention.

FIG. 5 is a photograph of a second locking module usable in conjunction with an orthodontic device, according to at least one embodiment of the present invention.

FIG. 6 is an operational flow for using an orthodontic device for orthodontic treatment, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

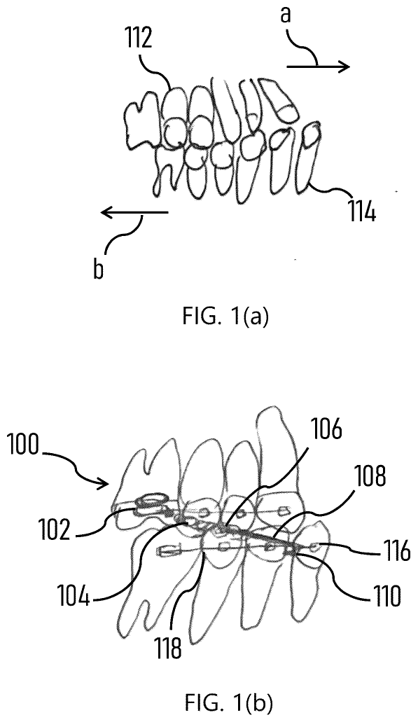

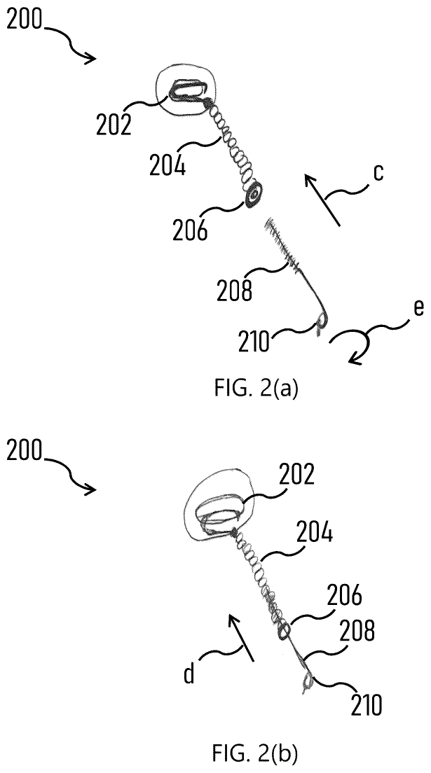

FIGS. 1(a) and 1(b) are corresponding views of an upper and lower set of teeth and an orthodontic device 100 correcting an upper jaw and/or teeth 112 and a lower jaw and/or teeth 114 having Class III skeletal and dental issues that need to be corrected, according to at least one embodiment of the present invention. Orthodontic device 100 includes a first locking module 102, a tension spring 104, a threaded portion 106, a pull rod 108, and a second locking module 110. In at least some embodiments, orthodontic device 100 is usable with braces and/or combined with other fixed appliances connected to upper jaw and/or teeth 112 and lower jaw and/or teeth 114 in early treatment of growing children or of adults. FIG. 1(a) shows an example of lower jaw and/or teeth 114 sitting more forward compared to upper jaw and/or teeth 112, which can be corrected by orthodontic device 100. Arrows a and b in FIG. 1(a) show directions of movement needed for upper jaw and/or teeth 112 and lower jaw and/or teeth 114 respectively, in order to correct the Class III skeletal and dental issues, according to at least one embodiment of the present invention. FIG. 1(b) shows an example of orthodontic device 100 in use for correcting the Class III skeletal and dental issues of FIG. 1(a), according to at least one embodiment of the present invention. In at least some embodiments, first locking module 102 of orthodontic device 100 is mounted on an orthodontic mount (also referred to as a band) on an upper molar or upper teeth 112 of a patient. In at least some embodiments, second locking module 110 of orthodontic device 100 is connected with orthodontic wire 118 between bicuspid mounts 116 on lower teeth 114. In at least some embodiments, the correction of skeletal and dental issues can be performed by an orthodontic device 200 shown in FIGS. 2(a) and 2(b), which will be explained hereinafter.

FIGS. 2(a) and 2(b) are views of orthodontic device 200, according to at least one embodiment of the present invention. In at least some embodiments, orthodontic device 200 is similar to orthodontic device 100 shown in FIG. 1(b). Orthodontic device 200 includes a first locking module 202, a tension spring 204, a threaded portion 206, a pull rod 208, and a second locking module 210. In at least some embodiments, tension spring 204 is connected to first locking module 202 at one end and is connected to second locking module 210 of pull rod 208 through threaded portion 206 at an opposite end. In at least some embodiments, tension spring 204 and pull rod 208 are assembled to be a variable tension pull rod. In at least some embodiments, the variable tension pull rod has a two-piece construction. FIG. 2(a) is a view of orthodontic device 200 before connecting pull rod 208 to tension spring 204, according to at least one embodiment of the present invention. FIG. 2(b) is a view of orthodontic device 200 after connecting pull rod 208 to tension spring 204, according to at least one embodiment of the present invention.

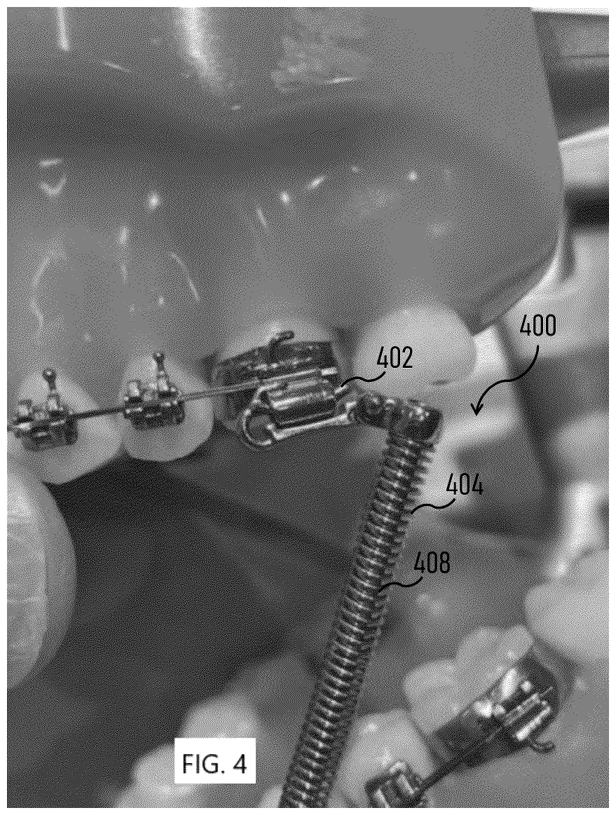

First locking module 202 is configured to connect tension spring 204 to an orthodontic mount (also referred to as a band) on an upper molar of a patient. In at least some embodiments, first locking module 202 is an engagement clip. In at least some embodiments, first locking module 202 is connected to an end of an elongated spring. In at least some embodiments, first locking module 202 is slidingly engageable from the back of the mouth toward the front. In at least some embodiments, first locking module 202 is similar to one of an EZ module (e.g., a Forsus™ Fatigue Resistant Device EZ Module available from 3M Corporation, see https://multimedia.3m.com/mws/media/407467O/forsus-fatigue-resistant-device-ez-module-parts-list.pdf) or another retaining module. In some embodiments, first locking module 202 is configured to push and slide and lock from the back of a mouth to the front (different from the EZ module) connected to pull rod 208. In at least some embodiments, due to a bias of tension spring 204, first locking module 202 is securely retained being pulled from the back to the front. In at least some embodiments, first looking module 202 is similar to the EZ module, and FIG. 4 provides a view of the EZ module in use for the correction of a different issue using a “Forsus™” appliance, which will be explained hereinafter.

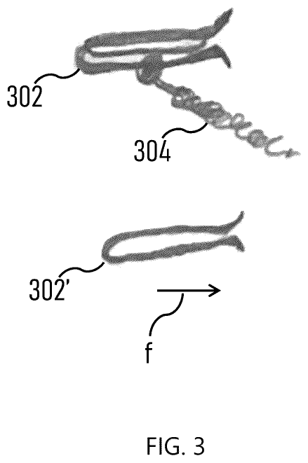

In at least some embodiments, first locking module 202 is a snap hook 302 which is configured to slide from the back to front instead, and snap locks gently. In at least some embodiments, snap hook 302 being first locking module 202 need not lock very tightly because the patient or a parent should be able to remove the locking module and there is a natural pull force on the module once in position, so the module will stay in place. In at least some embodiments, first locking module 202 is a snap hook 302 shown in FIG. 3, which will be explained hereinafter.

Tension spring 204 is configured to connect first locking module 202 and second locking module 210 at two opposite ends of tension spring 204 respectively. In at least some embodiments, tension spring 204 is an elongated spring with a threaded portion at one end. In at least one embodiment, tension spring 204 includes a portion at one end configured to engage with a threaded portion being inserted therein, e.g., a threaded portion of pull rod 208 described below. In at least some embodiments, depending on the application, tension spring 204 may have various sizes. In at least some embodiments, in a Class III correction application, tension spring 204 is shorter in length. In at least some embodiments, in a Class II correction application, tension spring 204 is longer in length. In other embodiments, tension spring 204 has a larger or smaller amount of elastic force to assist with pushing or pulling tension.

In at least some embodiments, a size of tension spring 204 is generally about 23 mm, for Class II (Forsus™-like) correction. In at least some embodiments, after activation, tension spring 204 should not exert more than about 4-6 oz of pressure in either case. In at least some embodiments, at least one benefit of orthodontic device 200 is that the device is easily adjusted to create the forces needed by threading in and out. In Class III correction, there is a possibility that the span might be longer due to the longer lower jaw size. In at least some embodiments, tension spring 204 is kept about the same size in Class III correction as the size of tension spring in Class II correction, in such a way, tension spring 204 is made to have both pulling and pushing capabilities and is contemplated to work as well. In at least some embodiments, tension spring 204 is in three sizes of 23 mm, 25 mm, or 27 mm, which give the operator flexibility. In at least some embodiments, longer or shorter lengths of tension spring 204 are usable.

Threaded portion 206 is configured to connect tension spring 204 with pull rod 208. In at least some embodiments, orthodontic device 200 is a metallic two-piece construction having elongated tension spring 204 with threaded portion 206 at one end, and pull rod 208 with a correspondingly threaded portion to fit into threaded portion 206 of tension spring 204. The opposite end of elongated tension spring 204 from the threaded portion has first locking module 202 connected thereto. The opposite end of threaded pull rod 208 from the threaded portion has second locking module 210 connected thereto. In at least some embodiments, threaded portion 206 is a screw hole, and pull rod 208 is screwed in the screw hole.

Pull rod 208 is configured to have a threaded end connected to tension spring 204 through threaded portion 206 and a second locking module located at another end connected with orthodontic wire 118 between bicuspid mounts 116 on lower teeth 114. In at least some embodiments, pull rod 208 is threaded on one end which is configured to be threaded into tension spring 204, and the other end of pull rod 208 has second locking module 210 or spring lock soldered to pull rod 208. In at least some embodiments, pull rod 208 is a threaded rod with a correspondingly threaded portion to fit into the spring threaded portion.

Pull rod 208 is adjustable and is also referred to as pull/push rod 208. Pull/push rod 208 can be screwed in or out of the spring 204 for different kinds of activation, as needed. If pull/push rod 208 is turned counterclockwise the rod unscrews, and gets longer and with a clockwise rotation the rod gets shorter. Each complete turn has a pitch ranging from 0.05 to 1 mm. Because this will be removable and we do not want the activation to get lost by accidentally being able to turn pull/push rod 208 easily, in an embodiment rod 208 includes measurement markings. In an embodiment, the markings are laser etched along rod 208. This can be indicated in millimeters on the pull/push rods. In an embodiment, rod 208 is configured to click to stabilize with each complete turn, or has enough friction so it won't turn with ease. Therefore, when we activate, we can instruct the patient that the pull/push rod 208 is on a particular activation level (3 mm, 5 mm, or the like . . . ) so if they accidentally turned the rod, they know at what activation level rod 208 needs to be set. This is applicable for both braces and aligner designs to keep it simple.

For the aligners or even braces, the arm and the push rods are made in tooth color or clear strong and rigid acrylic (safe for dental) materials, and (in an embodiment) only keep the spring in stainless (if need be for efficacy) or even white color springs. We want them to look incognito and actually they will be, because they attach from the upper molars to the lower cuspids areas, and they get covered with the cheeks very nicely. Also, they will be lighter in weight and stay mouth-friendlier.

The spring 204 size generally is about 23 mm, for Class II (Forsus-like) correction and after activation the spring 204 should not exert more than about 4-6 oz of pressure in either case, in some embodiments. At least one benefit of an embodiment of this device is that it is easily adjusted to create the forces needed by threading in and out. In Class III correction, there is a possibility that the span might be longer due to the longer lower jaw size, so keeping the spring of about the same size (in such a way that the spring 204 is made to have both pulling and pushing capabilities) is contemplated to work as well. Having springs in three sizes of 23-, 25-, or 27 mm gives the operator flexibility. In some embodiments, longer or shorter spring 204 lengths are usable. In at least one embodiment, a total push/pull rod of about 30 mm in length with the threaded portion of about 6-8 mm again will be sufficient to create a pull (threaded in thus shorter) or push (threaded out to make longer) action. In a Forsus-style arrangement embodiment, the spring 204 size is always the same as about 23 mm, and we have different size rods to be able to activate initially. An issue that arises in other approaches is if the patient opens the mouth wide, the rod and the spring sometimes may separate due to its design and can potentially hurt the patient. In at least one embodiment of the present invention, the spring 204 can never be separated no matter how wide the patient opens, because the two pieces are screwed together.

In operation, the first locking module is attached to an upper molar of the patient. The threaded rod 208 is threaded into the spring 204 to a first distance or depth. In at least one embodiment, the first distance is two millimeters. The second locking module is attached to a wire segment between two mounts (brackets) on the lower teeth of the patient. The length of the variable tension pull rod when the spring 204 is not under tension and the threaded rod is attached is less than the distance from the upper molar attachment point to the closer of the two lower brackets on the teeth. In at least some embodiments, the threaded rod 208 is turned to be threaded into the spring 204 while leaving an additional four millimeters (4 mm) of threading available on the threaded rod 208. In this manner, when attaching the second locking module to the wire segment, the spring 204 is put under tension and stays active (under tension) at all times. Thus, when the patient opens his mouth, the tension in the pull rod 208 results in even a more but yet gentle pulling motion (back into the patient's mouth) on the lower teeth and a pushing motion (out of the patient's mouth) on the upper teeth. In some embodiments, the additional threading is about 6 mm instead of 4 mm. A goal of the additional threading is to impart a range of tension from about 6 ounces to about 8 ounces of force. In at least one embodiment, each complete rotation of the threaded rod 208 into the spring adjusts the tension force by 2 ounces of forces due to shortening the span of the device.

As the teeth shift, the spring 204 becomes less under tension. At a later time (after sufficient movement of teeth), the second locking module is easily disconnected from the wire segment of the lower braces by unlocking the spring ring lock, and the threaded rod 208 is turned in clockwise to be threaded further into the spring 204. In other embodiments, the threading in the rod 208 and spring 204 is such that the threaded rod 208 is turned counter-clockwise to be threaded further into the spring 204. The overall length of the variable tension pull rod 208 is thereby reduced. In some embodiments, the threaded rod 208 is turned each time to reduce the overall length by one millimeter. In some embodiments, each turn of the threaded rod 208 reduces the overall length by more or less than one millimeter. The second locking module is then reattached to the same wire segment thereby putting the spring 204 into tension and continuing to pull on the lower teeth and push on the upper teeth. The process is then repeated.

Thus, the doctor is able to vary the amount of force being applied to the movement of the teeth by greater or lesser threading of the threaded rod 208 into the spring 204. Additionally, repositioning of the attachment is simplified using the second locking module. Current approaches using a Forsus appliance require the crimping of wire ends in the mouth of the patient which is uncomfortable, awkward, time consuming, and with the possibility of harm to the patient.

In another embodiment, the device is used in a push manner to create separation. That is, the spring 204 part provides elastic force to push the upper first locking module away from the lower second locking module. In this manner, the upper teeth are pushed toward the back of the patient mouth and the lower teeth are pushed toward the front of the mouth. Adjustments to the threaded part cause the threaded part to be removed from the spring 204 rather than inserted deeper. In at least some embodiments, at least a portion of the push rod 208 near the second locking module is angled to minimize the rod from flipping out into the patient's cheek. In at least some embodiments, depending on the application, the tension spring 204 has a different size. For example, in a Class III correction application, the spring 204 is shorter in length. In a Class II correction application, the spring 204 is longer in length. In other embodiments, the tension spring 204 has a larger or smaller amount of elastic force to assist with pushing or pulling tension.

In at least some embodiments, a total length of pull rod 208 is about 30 mm with the threaded portion of about 6-8 mm, which will be sufficient to create a pull (threaded in to make the total length of pull rod 208 and tension spring 204 shorter) or push (threaded out to make the total length of pull rod 208 and tension spring 204 longer) action. In at least some embodiments, in a Forsus™-style arrangement, the size of tension spring 204 is always the same as about 23 mm, and pull rod 208 has different sizes to be able to activate initially. In other conventional approaches, an issue arises when the patient opens the mouth wide, the pull rod and the tension spring sometimes may separate due to its design and can potentially hurt the patient. In at least some embodiments of the present invention, tension spring 204 will not be separated with pull rod 208, no matter how wide the patient's mouth opens, because tension spring 204 and pull rod 208 are screwed together through threaded portion 206.

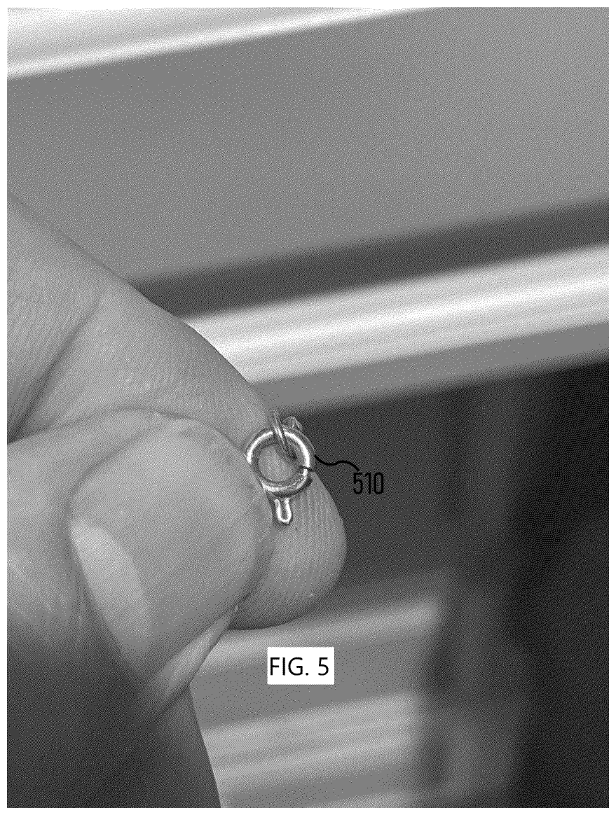

Second locking module 210 is configured to connect pull rod 208 to a portion of orthodontic wire 118 between two bicuspid mounts 116 on lower teeth 114 of a patient. In at least some embodiments, second locking module 210 is a spring ring type clasp which is connected at one end of pull rod 208. In at least some embodiments, second locking module 210 is connected to an end of a threaded rod. In at least some embodiments, second locking module 210 is at one end of pull rod 208 opposite to the other end of the pull rod 208 where first locking module 202 is located. In at least some embodiments, second locking module 210 is hingedly or rotationally crimped at the end of pull rod 208. The spring ring type clasp enables quick and easy release of second locking module 210 and pull rod 208 from orthodontic wire 118. In at least some embodiments, second locking module 210 can then be repositioned between the same two mounts or between two different mounts on lower teeth 114 of the patient. In at least some embodiments, second locking module 210 is a spring ring type clasp 510 shown in FIG. 5, which will be explained hereinafter.

In at least some embodiments, orthodontic device 200 is used in a push manner to create separation. That is, in at least some embodiments, tension spring 204 provides elastic force to push the upper first locking module 202 away from the lower second locking module 210. In this manner, upper teeth 112 are pushed toward the back of the patient mouth and lower teeth 114 are pushed toward the front of the mouth. In at least some embodiments, adjustments made to threaded portion 206 cause threaded portion 206 to be removed from tension spring 204 rather than inserted deeper. In at least some embodiments, at least a portion of the pull rod 208 near second locking module 210 is angled to minimize pull rod 208 from flipping out into the patient's cheek.

In FIGS. 2(a) and 2(b), arrows c and d show a direction of movement needed for pull rod 208 to be threaded into tension spring 204. Arrow e shows a direction of movement that pull rod 208 is turned to be threaded into the spring. In at least some embodiments, the threading in pull rod 208 and tension spring 204 is such that the threaded pull rod 208 is turned to be threaded further into the spring, and an overall length of pull rod 208 and tension spring 204 is thereby reduced.

Orthodontic device 200 is able to correct both Class II and Class III conditions depending on how the device is adjusted, i.e., whether to keep the spring under pulling tension by shortening the span of the device or to make the spring active by lengthening the span of the device. In a first configuration, the spring is kept under pulling tension by screwing the pull/push rod clockwise to shorten the span of the assembly, thereby creating a pulling action to correct the Class III malocclusion when the spring is pulled to connect the spring hook of the rod on the orthodontic wire. In a second configuration, the spring is made active by rotating the pull/push rod counterclockwise to make the assembly longer and to create a pushing action by compressing the spring and to lock the spring hook of the rod on the orthodontic wire thus to correct a Class II malocclusion (similar action to the Forsus). The snap hook of the spring slides from back to front on the molar band tube for Class III and from front to back in Class II corrections to prevent the hook from coming out while in use, due to the corrective forces being exerted. The same spring can be reversed from left side to the right and vice versa to achieve this depending on the malocclusion type that is getting corrected. For example, the right spring that is used for Class III can be used on the left for Class II.

FIG. 3 shows views of snap hook 302 usable as first locking module 202 in conjunction with orthodontic device 200, according to at least one embodiment of the present invention. In at least some embodiments, snap hook 302 is configured to slide from the back to front instead. In at least some embodiments, snap hook 302 locks gently to allow the patient or a parent to remove first locking module 202. In at least some embodiments, snap hook 302 or first locking module 202 which is connected to the upper molar tube, is pre-connected onto a tension spring 304 (with a ball joint) to allow for ease of movement during mastication. In at least some embodiments, tension spring 304 is connected to the upper molar tube by sliding back to front using snap hook 302. In at least some embodiments, snap hook 302 is pre-connected prior to use, e.g., at the factory, to tension spring 304 via a ball joint to allow ease of movement. In at least some embodiments, the threaded part of pull rod 208 gets threaded into tension spring 304 to be able to create a pull, and that pull occurs upon pulling tension spring 304 and connection of the “spring ring” in between the lower bicuspid brackets on the orthodontic wire or other fixed appliances. In at least one embodiment, the connection of the “spring ring” takes no more than 1-2 minutes. In at least some embodiments, for future activations, the spring ring gets disconnected from the wire in seconds, threaded into tension spring 304 to make orthodontic device 200 shorter and pulled to reconnect the spring clasp. In at least some embodiments, installations, adjustments and removals of orthodontic device 200 can be performed all in seconds after proficiency. In at least some embodiments, tension spring 304 is similar to tension spring 204. In at least some embodiments, snap hook 302′ is an enlarged view of snap hook 304, and an arrow f shows a direction of force applied to snap hook 302′ when connecting tension spring 304 to the upper molar tube.

FIG. 4 is a photograph of another approach to a first locking module 402 of an orthodontic device 400, according to at least one embodiment of the present invention. In at least some embodiments, first locking module 402 is similar to the EZ module, and FIG. 4 shows first locking module 402 in use for the correction of a issue using a “Forsus™” appliance. In some embodiments, first locking module 402 is configured to push and slide and lock from the back of a mouth to the front to connect a tension spring 404 to a pull rod 408.

FIG. 5 is a photograph of a second locking module 510 usable in conjunction with orthodontic device 200, according to at least one embodiment of the present invention. In at least some embodiments, second locking module 510 is a spring ring type clasp as seen in FIG. 5. In at least some embodiments, at least a portion of pull rod 208 near second locking module 510 is angled to minimize pull rod 208 from flipping out into the patient's cheek.

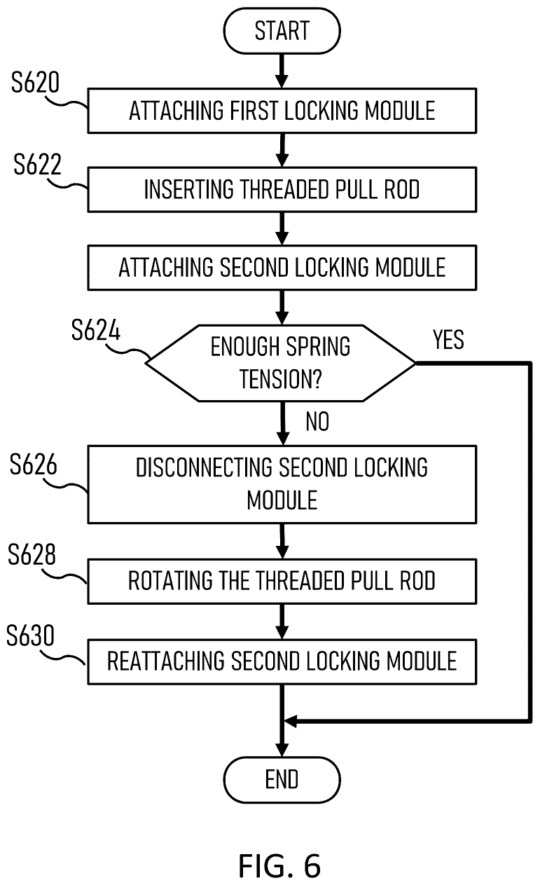

FIG. 6 is an operational flow for using an orthodontic device for orthodontic treatment, according to at least one embodiment of the present invention. The operational flow provides a method for orthodontic treatment. In at least some embodiments, the method is performed by using an orthodontic device, such as orthodontic device 200 shown in FIG. 2.

At S620, the first locking module is attached. In at least some embodiments, the first locking module is attached to an upper tooth band of a patient. In at least some embodiments, the first locking module may be first locking module 202 shown in FIGS. 2(a) and 2(b) or first locking module 302 shown in FIG. 3.

At S622, the threaded pull rod is inserted. In at least one embodiment, the threaded pull rod is inserted into the elongated tension spring to a first distance or depth. In at least one embodiment, the first distance or depth is 2 mm. In at least some embodiments, the pull rod may be pull rod 208 shown in FIGS. 2(a) and 2(b).

At S624, the second locking module is attached. In at least some embodiments, the second locking module is attached to a wire segment between two mounts (brackets) on the lower teeth of the patient. In at least some embodiments, the second locking module may be second locking module 210 shown in FIGS. 2(a) and 2(b) or second module 510 shown in FIG. 5.

At S624, whether there is enough spring tension is determined. In at least some embodiments, whether the tension spring has enough tension is determined after the second locking module is attached. When the tension spring is not under tension and the threaded rod is attached, the length of the variable tension pull rod is less than the distance from the upper molar attachment point to the closer of the two lower brackets on the teeth. In at least some embodiments, the threaded pull rod is turned to be threaded into the spring while leaving an additional 4 mm of threading available on the threaded pull rod. In this manner, when attaching the second locking module to the wire segment, the tension spring is put under tension and stays active (under tension) at all times. Thus, when the patient opens his/her mouth, the tension in the pull rod results in an even more but yet gentle pulling motion (back into the patient's mouth) on the lower teeth and a pushing motion (out of the patient's mouth) on the upper teeth. In at least some embodiments, the additional threading is about 6 mm instead of 4 mm, and a goal of the additional threading is to impart a range of tension from about 6 ounces to about 8 ounces of force. In at least some embodiments, the initial length of the threaded pull rod extending outside the elongated tension spring is at least 6 mm. In at least some embodiments, each complete rotation of the threaded rod into the spring adjusts the tension force by 2 ounces of forces due to shortening the span of the device. In at least some embodiments, the tension of the variable tension pull rod ranges from 0 to 8 ounces of force. In response to the tension spring having not enough tension, the operational flow proceeds to disconnection of the second locking module at S626. In response to the tension spring having enough tension, the operational flow ends.

At S626, the second locking module is disconnected. In at least some embodiments, the second locking module is disconnected from the wire segment.

At S628, the threaded pull rod is rotated. In at least some embodiments, the threaded pull rod is rotated to extend further into the elongated tension spring. In at least some embodiments, the threaded rod is rotated by making a single turn of the threaded rod within the elongated tension spring. In at least some embodiments, each single turn results in a 1 mm reduction in the length of the orthodontic device. In at least some embodiments, each single turn results in an increase in force of 1 ounce.

At S630, the second locking module is reattached. In at least some embodiments, the second locking module is reattached to the wire segment.

As the teeth shift, the tension spring is under less tension. In at least some embodiments, after sufficient movement of teeth, the second locking module is disconnected from the wire segment of the lower braces by unlocking the spring ring lock, and the threaded pull rod is turned in clockwise to be threaded further into the spring. In at least some embodiments, the threading in the pull rod and tension spring is such that the threaded pull rod is turned counter-clockwise to be threaded further into the tension spring. The overall length of the variable tension pull rod is thereby reduced. In at least some embodiments, each complete turn of the threaded pull rod imparts an additional 1 ounce of force. In at least some embodiments, the threaded pull rod is turned each time to reduce the overall length by 1 mm. In at least some embodiments, each turn of the threaded pull rod reduces the overall length by more or less than 1 mm. In at least some embodiments, the second locking module is then reattached to the same wire segment thereby putting the tension spring into tension and continuing to pull on the lower teeth and push on the upper teeth. In at least some embodiments, the process is then repeated when there is not enough tension on the tension spring.

In at least some embodiments, the doctor is able to vary the amount of force being applied to the movement of the teeth by greater or lesser threading of the threaded pull rod into the tension spring. In at least some embodiments, the amount of force is varied by rotating the threaded pull rod within the elongated tension spring. Current conventional approaches using a Forsus™ appliance require the crimping of wire ends in the mouth of the patient, which is uncomfortable and time consuming, and with the possibility of harm to the patient. In at least some embodiments according to the present invention, repositioning of the attachment is simplified using the second locking module.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device for orthodontic treatment comprising:
a variable tension pull rod having a two-piece construction including:
an elongated spring with a spring threaded portion at one end; and
a threaded rod with a correspondingly threaded portion to fit into the spring threaded portion;
a first locking module connected to an end of the elongated spring; and
a second locking module connected to an end of the threaded rod, wherein the second locking module is located opposite to the first locking module.

2. The device as claimed in claim 1, wherein the first locking module is an engagement clip.

3. The device as claimed in claim 1, wherein the first locking module is slidingly engageable from a back of a mouth towards a front of the mouth.

4. The device as claimed in claim 1, wherein the first locking module is a snap hook.

5. The device as claimed in claim 1, wherein the second locking module is a spring ring type clasp.

6. The device as claimed in claim 1, wherein the second locking module is hingedly crimped at the end of the threaded rod.

7. The device as claimed in claim 1, wherein the second locking module is rotationally crimped at the end of the threaded rod.

8. The device as claimed in claim 1, wherein the correspondingly threaded portion of the threaded rod is at least 6 mm in length.

9. The device as claimed in claim 1, wherein a tension of the variable tension pull rod ranges from 0 to 8 ounces of force.

10. The device as claimed in claim 1, wherein an amount of force is varied by rotating the threaded rod within the elongated spring.

11. The device as claimed in claim 10, wherein each complete turn of the threaded rod imparts an additional 1 ounce of force.

12. The device as claimed in claim 10, wherein each complete turn of the threaded rod adjusts a length of the device by 1 mm.

13. A method of using a device for orthodontic treatment, the device having a variable tension pull rod having a two-piece construction including an elongated spring with a spring threaded portion at one end and a threaded rod with a correspondingly threaded portion to fit into the spring threaded portion, comprising:
attaching a first locking module to an upper tooth band of a patient;
inserting the threaded rod into the elongated spring to a first depth; and
attaching a second locking module to a wire segment between two mounts on a lower teeth of the patient.

14. The method of claim 13, wherein the first depth is 2 mm.

15. The method of claim 13, wherein a length of the variable tension pull rod with the elongated spring not under tension and the threaded rod attached is smaller than a distance from an upper tooth band attachment point to a closer of the two mounts on the lower teeth.

16. The method of claim 13, wherein an initial length of the threaded rod extending outside the elongated spring is at least 6 mm.

17. The method of claim 13, further comprising:
disconnecting the second locking module from the wire segment;
rotating the threaded rod to extend further into the elongated spring; and
reattaching the second locking module to the wire segment.

18. The method of claim 13, wherein the rotating the threaded rod comprises a single turn of the threaded rod within the elongated spring.

19. The method of claim 18, wherein each single turn results in a 1 mm adjustment in a length of the device.

20. The method of claim 18, wherein each single turn results in an increase in force of 1 ounce.
